(19) United States
(12) Patent Application Publication
(10) Pub. No.: US 2023/0143098 A1
(43) Pub. Date: May 11, 2023

(54) SYSTEM AND METHOD FOR MATCHING EVENT RIGHT HOLDERS AND DESTINATION USERS

(71) Applicant: HUDDLE UP GROUP, LLC, PHOENIX, AZ (US)

(72) Inventors: CAROLINE ALLMAN, PHOENIX, AZ (US); JON SCHMIEDER, PHOENIX, AZ (US)

(21) Appl. No.: 17/890,065

(22) Filed: Aug. 17, 2022

Related U.S. Application Data
(60) Provisional application No. 63/240,059, filed on Sep. 2, 2021.

(51) Int. Cl. G06Q 30/0201; G06Q 50/10

(52) U.S. Cl. CPC G06Q 30/0201; G06Q 50/10

(57) ABSTRACT

A sports tourism index system may have an analysis section, a match section and an estimated spending calculator section. The analysis section may be designed to provide destinations users with a data-based output report. The results presented in the output report may be generated through calculations based on user data inputs. The analysis section includes a dynamic awards system called designations. Designations are levels earned based on how a destination’s score for their organization and facilities compares to the rest of the industry. These designations may dynamically change as new facilities and destinations input their data into the system. Blind rankings are available to destination users. This allows them to see their position relative to the overall rankings, rankings by market-size and by region. However, it does not allow a destination user to see where any other user ranks.

### RELATED APPLICATIONS

This patent application is related to U.S. Provisional Application No. 63/240,059 filed Sep. 2, 2021, entitled “SYSTEM AND METHOD FOR MATCHING EVENT RIGHT HOLDERS AND DESITINATION USERS” in the name of the same inventor, and which is incorporated herein by reference in its entirety. The present patent application claims the benefit under 35 U.S.C §119(e).

### TECHNICAL FIELD

The present application generally relates to sports tourism and, more particularly, to a system and method to help destinations evaluate their position in the sports tourism market and to match a destination user’s sports facilities with the needs of a rights holder user’s events.

### BACKGROUND

Sports tourism may be defined as an individual’s travel to a location for the specific purpose of either participating in or viewing a sporting event. Sports tourism is one of the fastest growing sectors in tourism. Recent surveys have reported that the sports tourism market may be poised to grow by $890.90 billion (USD) during the 2021-2025 timeframe, progressing at a Compound Annual Growth Rate (CAGR) of 13% during the forecast period. Youth sports tourism, a subset of sports tourism, is growing at a particularly rapid rate. Recent reports have valued the youth sports tourism industry alone at $15.8 billion just in the United States. It is further projected that youth sports tourism industry will double in size in the next few years.

However, many time it may be difficult to properly align destination users with the rights holder users. Destination users may represent their destination marketing organization such as convention and visitor bureau or sports commissions. Rights holder users may represent the events of their sports organization such as a national governing body or privately owned sports entities. Rights holders and destination users generally have different needs. Thus, most present systems are dedicated to either helping rights holders find a desired location or destination users find events to host. Presently, there is no system that that is designed to meet the different functionality required by both parties.

Therefore, it would be desirable to provide a system and method that overcome the above problems.

### SUMMARY

In accordance with one embodiment, a computer device is disclosed. The computing device has a processor, a display coupled to the processor, a user interface coupled to the processor for entering data into the computing device and a memory coupled to the processor, the memory storing program instructions that when executed by the processor, causes the processor to: connect with a server hosting a sports tourism index platform for matching event rights holders with municipality destination marketing organizations (DMOs); add a plurality of DMOs, wherein each DMO added includes name and contact information of each DMO, sporting facilities associated with each DMO, capacities of the sporting facilities associated with each DMO, parking facilities for the sporting facilities associated with each DMO, number of hotels within a predefined radius of each of the sporting facilities associated with each DMO, and staffing and budget of associated with each DMO; add a plurality of event rights holders, wherein each event rights holder added includes name and contact information of each event rights holders associated with each event rights holder, biographical information associated with each event rights holder, sporting events hosted by each event rights holder, and facility requirements of each sporting event hosted by each event rights holder; and match the sporting events of the plurality of event rights holders with each sporting facility of the plurality of DMOs that match the and facility requirements.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a block diagram of an exemplary sports tourism index system in accordance with one embodiment of the present invention;

FIG. 2 is a block diagram of an exemplary computing device used in the sports tourism index system of FIG. 1 in accordance with one embodiment of the present invention;

FIG. 3 shows an exemplary login page which may be displayed on the computing device used in FIG. 1 in accordance with one embodiment of the present invention;

FIG. 4 shows an exemplary registration page which may be displayed on the computing device used in FIG. 1 in accordance with one embodiment of the present invention;

FIG. 5 shows a section of an exemplary profile page which may be displayed on the computing device used in FIG. 1 in accordance with one embodiment of the present invention;

FIG. 6 shows a section of an exemplary profile page which may be displayed on the computing device used in FIG. 1 in accordance with one embodiment of the present invention;

FIG. 7 shows a section of an exemplary profile page which may be displayed on the computing device used in FIG. 1 in accordance with one embodiment of the present invention;

FIG. 8 shows a section of an exemplary profile page which may be displayed on the computing device used in FIG. 1 in accordance with one embodiment of the present invention;

FIG. 9 shows an exemplary menu for the profile page which may be displayed on the computing device used in FIG. 1 in accordance with one embodiment of the present invention;

FIG. 10 shows an exemplary sports tourism index report page which may be displayed on the computing device used in FIG. 1 in accordance with one embodiment of the present invention;

FIG. 11 shows an exemplary comparison sports tourism index report page which may be displayed on the computing device used in FIG. 1 in accordance with one embodiment of the present invention;

FIG. 12 shows an exemplary recommendation report page which may be displayed on the computing device used in FIG. 1 in accordance with one embodiment of the present invention;

FIG. 13 shows an exemplary rankings report page which may be displayed on the computing device used in FIG. 1 in accordance with one embodiment of the present invention;

FIG. 14 shows an exemplary designation certificate which may be displayed on the computing device used in FIG. 1 in accordance with one embodiment of the present invention;

FIG. 15 shows an exemplary library page which may be displayed on the computing device used in FIG. 1 in accordance with one embodiment of the present invention;

FIG. 16 shows an exemplary event finder page which may be displayed on the computing device used in FIG. 1 in accordance with one embodiment of the present invention;

FIG. 17 shows an exemplary event finder page which may be displayed on the computing device used in FIG. 1 in accordance with one embodiment of the present invention;

FIG. 18 shows an exemplary matchmaker page which may be displayed on the computing device used in FIG. 1 in accordance with one embodiment of the present invention;

FIG. 19 shows an exemplary saved events page which may be displayed on the computing device used in FIG. 1 in accordance with one embodiment of the present invention;

FIG. 20 shows a section of an exemplary organizational profile page which may be displayed on the computing device used in FIG. 1 in accordance with one embodiment of the present invention;

FIG. 21 shows a section of an exemplary organizational profile page which may be displayed on the computing device used in FIG. 1 in accordance with one embodiment of the present invention;

FIG. 22 shows a section of an exemplary organizational profile page which may be displayed on the computing device used in FIG. 1 in accordance with one embodiment of the present invention;

FIG. 23 shows a section of an exemplary organizational profile page which may be displayed on the computing device used in FIG. 1 in accordance with one embodiment of the present invention;

FIG. 24 shows an exemplary menu bar for the organizational profile page which may be displayed on the computing device used in FIG. 1 in accordance with one embodiment of the present invention;

FIG. 25 shows an exemplary new event input page which may be displayed on the computing device used in FIG. 1 in accordance with one embodiment of the present invention;

FIG. 26 shows an exemplary facility finder page which may be displayed on the computing device used in FIG. 1 in accordance with one embodiment of the present invention;

FIG. 27 shows an exemplary facility finder list page which may be displayed on the computing device used in FIG. 1 in accordance with one embodiment of the present invention;

FIG. 28 shows an exemplary facility matchmaker page which may be displayed on the computing device used in FIG. 1 in accordance with one embodiment of the present invention;

FIG. 29 shows an exemplary saved facilities page which may be displayed on the computing device used in FIG. 1 in accordance with one embodiment of the present invention;

FIG. 30 shows an exemplary library page which may be displayed on the computing device used in FIG. 1 in accordance with one embodiment of the present invention;

FIG. 31 shows an exemplary estimator spending calculator page which may be displayed on the computing device used in FIG. 1 in accordance with one embodiment of the present invention;

FIG. 32 shows an exemplary new event fields for the estimator spending calculator page which may be displayed on the computing device used in FIG. 1 in accordance with one embodiment of the present invention;

FIG. 33 shows an exemplary saved projections page which may be displayed on the computing device used in FIG. 1 in accordance with one embodiment of the present invention;

FIG. 34 shows an exemplary estimated spending projection page which may be displayed on the computing device used in FIG. 1 in accordance with one embodiment of the present invention;

FIG. 35 shows an exemplary state profile page which may be displayed on the computing device used in FIG. 1 in accordance with one embodiment of the present invention; and;

FIG. 36 shows an exemplary state profile page after a state has been selected which may be displayed on the computing device used in FIG. 1 in accordance with one embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary sports tourism index system may be comprised of an analysis section, a match section and an estimated spending calculator section. The analysis section may be designed to provide destinations users with a data-based output report. The results presented in the output report may be generated through calculations based on user data inputs. The analysis section includes a dynamic awards system called designations. Designations are levels earned based on how a destination’s score for their organization and facilities compares to the rest of the industry. For example, the designation levels may be platinum, gold, silver, or bronze. These designations may dynamically change as new facilities and destinations input their data into the system. Blind rankings are available to destination users. This allows them to see their position relative to the overall rankings, rankings by market-size and by region. However, it does not allow a destination user to see where any other user ranks.

The match section may be used to match the rights holder data input with a destination user’s sports facilities. The match section may use the system’s database of event bid information, developed from rights holder data input, in order to match a destination user’s sports facilities with the needs of a rights holder user’s events. The matches may be created using the data input provided directly from the destination users and the event data input provided from the event rights holder users. Destination users may be provided their matches through the user portal on a facility-by-facility basis. In addition to the match making functionality of the system, the whole event databases can be searched by users with a series of filters and sort functionalities. When a destination user finds an event that interest them, they can save the event. All of a destination user’s saved events get cataloged and stored in their portal. The destination user can then add notes to the saved event.

Referring now to FIG. 1, a sports tourism index system 10 (hereinafter system 10) may be shown. The system 10 may provide a sports tourism index platform 12 that may be configured to help destinations evaluate their position in the sports tourism market and to match a destination user’s sports facilities with the needs of a rights holder user’s events. The system 10 may have a server 14. The server 14 may be used to host the sports tourism index platform 12 of the present invention. Individuals 16 may use one or more computing devices 18 to access the sports tourism index platform 12 that may be hosted on the server 14. The computing devices 18 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a web browser 20. The web browser 20 may allow the computing device 18 to gain online access to a network 22 such as the World Wide Web. The web browser 20 may be Microsoft ® Internet Explorer, Google ® Chrome, Mozilla ® Firefox, Apple ® Safari or similar browsing applications. By connecting to the network 22, the computing device 18 may access a website 24 associated with the sports tourism index platform 12 hosted on the server 14.

Referring now to FIG. 2, the computing devices 18 may be described in more detail in terms of the machine elements that provide functionality to the systems and methods disclosed herein. The components of the computing devices 18 may include, but are not limited to, one or more processors or processing units 30, a system memory 32, and a system bus 34 that couple various system components including the system memory 32 to the processor 30. The computing devices 18 may typically include a variety of computer system readable media. Such media could be chosen from any available media that is accessible by the computing devices 18, including non-transitory, volatile and non-volatile media, removable and non-removable media. The system memory 32 could include one or more computer system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 18 may communicate with one or more external devices 46 such as a keyboard, a pointing device, a display 48, and/or any similar devices (e.g., network card, modern, etc.) that enable the computing device 18 to communicate with the server 14 (FIG. 1). In accordance with one embodiment, the display 48 may be a touchscreen to allow communication with the server. Such communication may occur via Input/Output (I/O) interfaces 50. Alternatively, the computing devices 18 may communicate with one or more networks such as a local area network (LAN), a general wide area network (WAN), and/or a public network (e.g., the network 24 shown in FIG. 1) via a network adapter 52. As depicted, the network adapter 52 may communicate with the other components of the computing device 18 via the bus 36.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

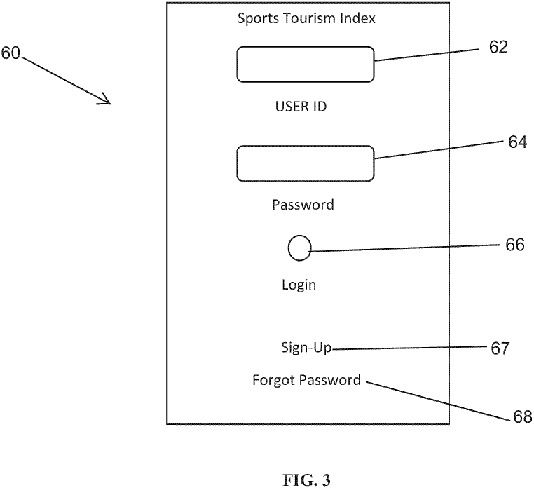

Referring to the FIGs., one embodiment of operation of the sports tourism index platform 12 may be described. To access the sports tourism index platform 12, individuals 16 may access the webpage 24 hosted on the server 14. Once the individual 16 accesses the webpage 24, the individual 16 may see a login screen 60 as shown in FIG. 3. The login screen 60 may have a User ID area 62 and a password area 64.

Once the individual 16 enters the corresponding user information in the User ID area 62 and the password area 64, the individual 16 may press the Login button 66 using an external device 46 (i.e., keyboard, mouse, etc.) of the computing device 18 of the individual 16. The user information may be sent to the server 14 hosting the sports tourism index platform 12 for verification. If the user information of the individual 16 is verified, the individual 16 may be sent to a personalized profile page of the individual 16 which may be described below. A link 68 may be provided if the individual 16 cannot remember his/her User ID/password. By selecting the link 68 using an external device 46 of the computing device 18 of the individual 16, the individual 16 may be sent to reset password page.

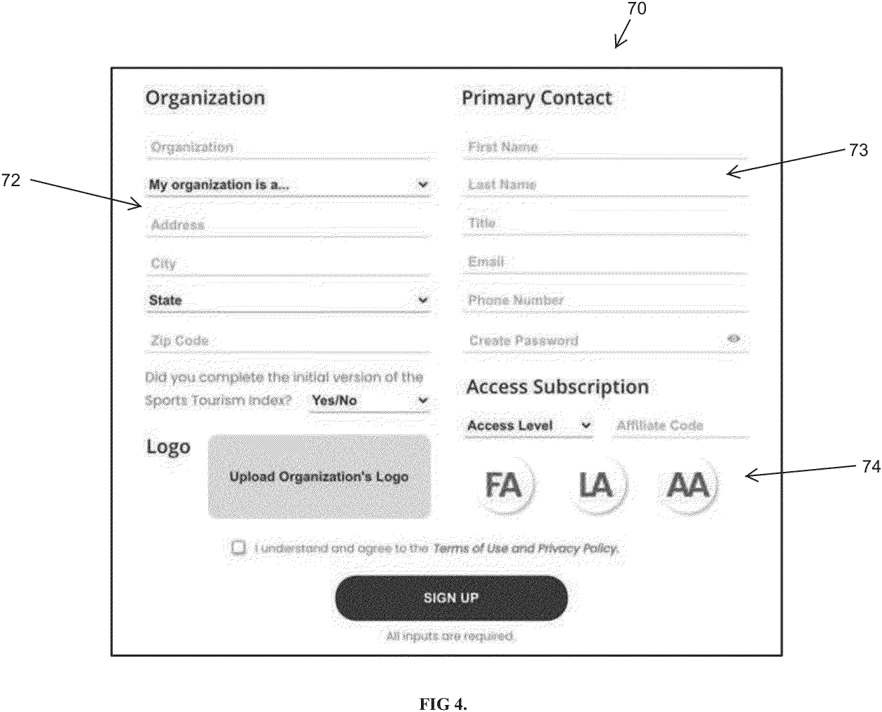

If the individual 16 is new to the sports tourism index platform 12, the login screen 60 may have a sign-up link 67. The sign-up link 67 may allow for the individual 16 to register and become a member of the sports tourism index platform 12. By selecting the link 67 using an external device 46 of the computing device 18 of the individual 16, the individual 16 may be sent to a registration page 70 as shown in FIG. 4.

Signing up requires a user to complete a series of questions about their organization as seen in FIG. 4. The registration page 70 may have an organizational information section 72. The organizational information section 72 may include, but is not limited to: organizational name, type of organization, address of the organization, password and similar information. The organizational information section 72 may also include an area for uploading a logo of the organization.

The organizational information section 72 may include an area 73 for entering primary contact information of an individual associated with the organization. The registration page 70 may include a subscription access level section 74. The subscription access level section 74 may allow the individual 16 the ability to select a type of subscription access as may be described below.

Once the individual 16 enters the corresponding information in the organizational information section 72 and the subscription access level section 74 using an external device 46 (i.e., keyboard, mouse, etc.) of the computing device 18 of the individual 16, the individual 16 may press the Submit button 76 using an external device 46 (i.e., keyboard, mouse, etc.) of the computing device 18 of the individual 16. The sign-up information submitted by the individual 16 may be sent to the server 14 hosting the sports tourism index platform 12 for verification. If the sign-up information is verified, based on the organization type selected, the sports tourism index platform 12 may direct the individual 16 to the proper portal and assigns it to their account. For example, if the individual 16 is a Destination Marketing Organization (DMO) (Convention and Visitors Bureau (CVB)/Sports Commission), then the individual 16 may be sent to the destination portal. If the individual 16 is a Rights Holder, the individual 16 may be sent to the rights holder portal. However, if other types of entities try to sign up, the individual 16 may be denied. For example, if the individual 16 is a sports facility, the individual 16 may be presented with a message explaining that they are not able to sign up at this time, and if the individual 16 is a hotel, the individual 16 may be presented with a message explaining that they are not able to sign up at this time. The above is given as examples and should not be seen in a limiting manner.

For the DMO (CVB/Sports Commission), the individual 16 may be sent to the destination portal. However, based on the access level selected the DMO (CVB/Sports Commission) user may be sent directly to their personal portal or to a payment page. As may be seen in FIG. 4, registration page 70 allows the individual 16 associated with the DMO (CVB/Sports Commission) to select access level via the access level section 74.

In accordance with one embodiment, the sports tourism index platform 12 may offer free access, limited access and all access. The amount of information provided will be based on the access level selected. If the DMO (CVB/Sports Commission) user selected free access, the DMO (CVB/Sports Commission) user may be sent directly to the destination portal. If the DMO (CVB/Sports Commission) user selected limited access and all access, the DMO (CVB/Sports Commission) user may be sent to a payment page if the DMO (CVB/Sports Commission) user had not previously paid for their subscription and/or if the subscription is not up to date. The payment page provides the user with the option of paying online via a secured online transaction. For example, the DMO (CVB/Sports Commission) user may be able to pay online by a credit card through a Stripe API integration. Alternatively, the DMO (CVB/Sports Commission) user may requesting an invoice be sent. Once the payment is submitted or invoice is requested, the user will be directed to the destination portal.

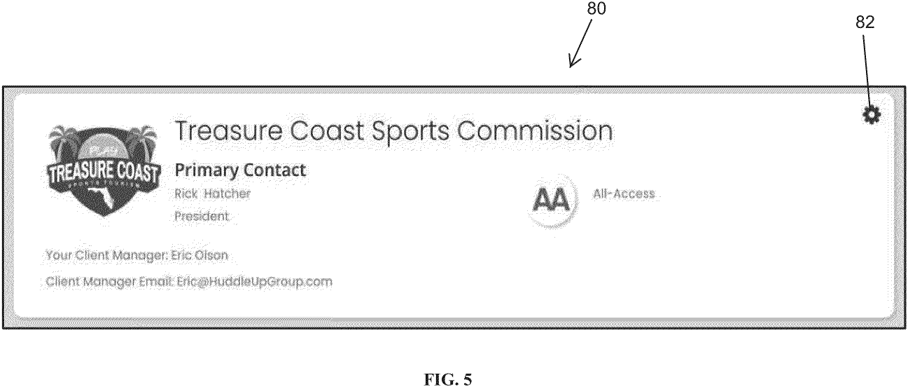

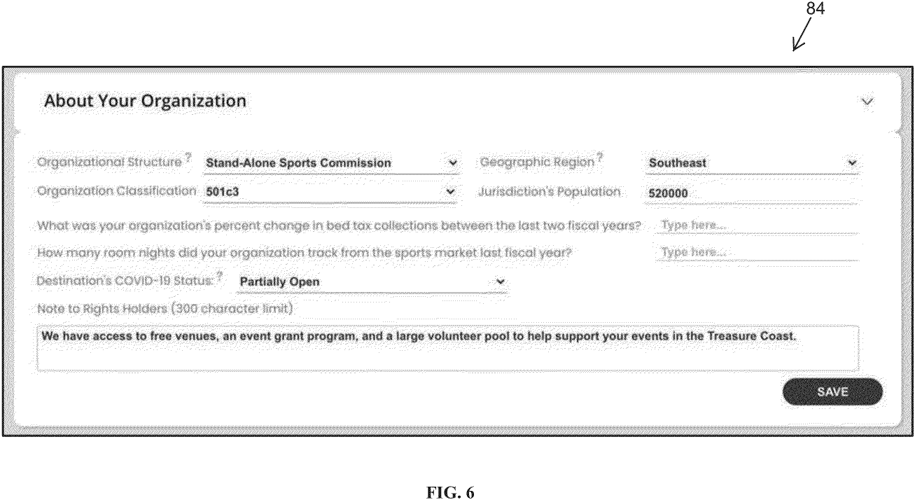

When DMO (CVB/Sports Commission) user logs in and sent to the destination portal, the DMO (CVB/Sports Commission) user may be directed to their organization profile page. As shown in FIGS. 5-8, the organization profile page may have a plurality of different sections. As may be seen in FIG. 5, the profile page may have an information section 80. The information section 80 may show basic information of the DMO (CVB/Sports Commission) user. For example, the information section 80 may display the organization name, logo, contact information, access level, client manager, and similar organizational information. This information can be updated by the user at any time. For example, the DMO (CVB/Sports Commission) user may click on an edit icon 82 and update any of the information by using an external device 46 (i.e., keyboard, mouse, etc.) of the computing device 18 of the individual 16.

As may be seen in FIG. 6, the profile page may have an organizational section 84. The organizational section 84 may provide more in-depth information related to the DMO (CVB/Sports Commission) user. As may be shown in FIG. 6, the organizational section 84 may show the organizational structure, geographic region where the organizational headquarters may be located, organizational classification as well as other organizational information. The organizational section 84 may include an area for the DMO (CVB/Sports Commission) user to provide notes about the organization to the rights holder user.

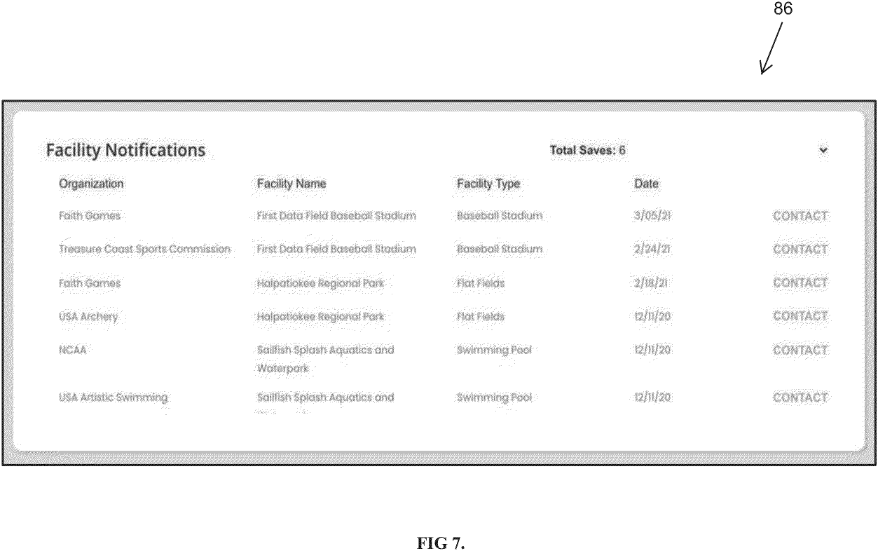

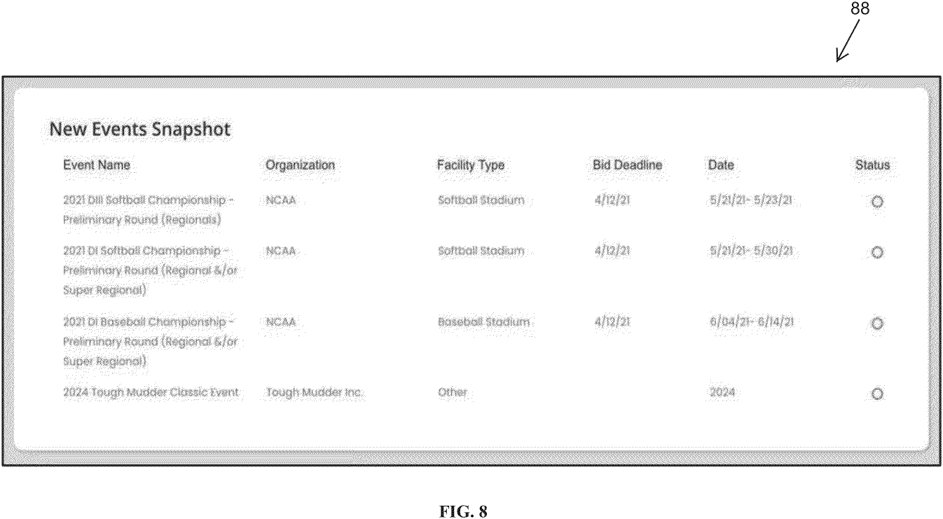

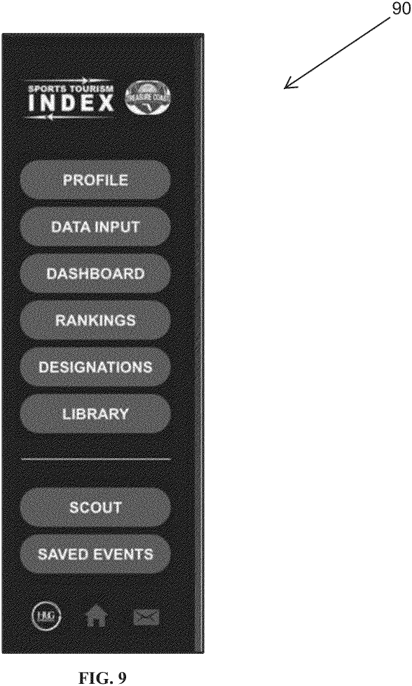

The profile page may have a facility notification section 86. When a rights holder user saves a facility of the DMO (CVB/Sports Commission) user, the DMO (CVB/Sports Commission) user may receive a notification in this section of the profile page as shown in FIG. 7. The facility notification section 86 may display the organization name of the user who saved the facility, the name of the facility being saved, the ate the facility was saved as well as contact information for the rights holder.

The profile page may have a new event section 88 as may be seen in FIG. 8. The new event section 88 may display recently added events that may be open for bid by the DMO (CVB/Sports Commission) user. The sports tourism index platform 12 may set the number of events that may be displayed. For example, the new event section 88 may display the 30 most recently added events open for bid. Alternatively, the sports tourism index platform 12 may allow the DMO (CVB/Sports Commission) user to select how many open events may be displayed on the new event section 88. The above are given as examples and should not be seen in a limiting manner. The new event section 88 may display different information related to the new event. This may include, but is not limited to: event name, organization hosting the event, facility type needed, bid date, date of the event, status, as well as other similar information.

The profile page may have a menu 90 as may be seen in FIG. 9. The menu 90 may allow the DMO (CVB/Sports Commission) user to select a tab to go to a desired page and/or to see desired information. By using an external device 46 (i.e., keyboard, mouse, etc.) of the computing device 18, the DMO (CVB/Sports Commission) user may move an icon to a desired menu item to view the corresponding information. The menu options may be determined by the access level of the account. For example, if the DMO (CVB/Sports Commission) user has All Access, the menu options may include: Profile, data input, dashboard, rankings, designations, library, match area, saved events, and similar information. If the DMO (CVB/Sports Commission) user has limited access or free access, the menu options may be limited. For example, the menu options may be limited to: Profile, data input, dashboard, rankings, designations, library and the like.

The DMO (CVB/Sports Commission) user may need to enter data in order for the sports tourism index platform 12 to calculate accurate result information. By using an external device 46 (i.e., keyboard, mouse, etc.) of the computing device 18, the DMO (CVB/Sports Commission) user may move to the data input tab on the menu 90. Once selected, the data input section may allow the DMO (CVB/Sports Commission) user to answer a series of questions related to what facilities/services the DMO (CVB/Sports Commission) user may provide. In accordance with one embodiment, the data input section may have four categories for the DMO (CVB/Sports Commission) user to enter information. These categories may include, but are not limited to: facilities available, destination strength, organizational structure and events.

In the facilities section, the DMO (CVB/Sports Commission) user may list the different facilities and the amenities available at each facility. These facilities may include participant-based facilities as well as spectator-based facilities. For example, participant-based facilities may include, but are not limited to:
BMX
Bowling
Cross Country
Diamonds
Disc Golf Courses
Equestrian
Flat Fields
Golf Course
Ice (Excluding One Sheet Arenas)
Indoor Courts (Basketball/Volleyball)
Indoor Track
Outdoor Track
Pickleball Courts
Shooting Range
Swimming Pool
Tennis (Indoor or Outdoor)
Theaters
Water Sports
Winter Sports
Other
Multiple facility types are needed

Participant-based facilities may include, but are not limited to:
Arena
Baseball Stadium
Football Stadium
Soccer Stadium
Softball Stadium
Motor Sports Racing Track

Other information in the facilities section may include conventions center spaces as well as future facilities that have or will be funded and if the DMO (CVB/Sports Commission) user has a dedicated facility funding source for new facility development.

For each facility, the DMO (CVB/Sports Commission) user may be asked a plurality of questions. For example, these questions may be about the size and accommodations of the facility, seating capacity of the facility, parking spaces available at the facility, if the facility is ADA compliant, and how many usable and committable hotel rooms are within a 15-minute drive of the facility and the like.

In the Destination Strength area, the DMO (CVB/Sports Commission) user may have to answer a plurality of questions related to tourism drivers, local hotels and restaurants transportation and accessibility around the location. For example, the sports tourism index platform 12 may ask questions such as, but not limited to: How many hotels rooms does your community have within the designated driving range from your city center/facility? How many restaurants are in your community? How many cities (population: 350,000+) can be reached by car within the designated driving distances? Which category best describes your largest airport? As well as similar types of questions.

In the organizational structure section, the DMO (CVB/Sports Commission) user may have to provide information related to the organizational structure of the DMO (CVB/Sports Commission). For example, the DMO (CVB/Sports Commission) user may disclose the budget and staff of the DMO (CVB/Sports Commission), grant programs, board and advisory group structure, community outreach and recognition, as well as similar information. In order to gather this information, the sports tourism index platform 12 may ask questions such as, but not limited to: What is the number of staff members your organization has solely dedicated to sports? What is your total sports budget not including staff salaries? How much of your sports budget is specifically set aside for travel to industry conferences, relationship building, familiarization tours, sales missions, and networking? Does your organization have a grant program or other funding to support events? As well as similar types of questions.

In the organizational structure section, the DMO (CVB/Sports Commission) user may have to provide information related to local events as well as bid-on events. In order to gather this information, the sports tourism index platform 12 may ask questions such as, but not limited to: How many annual/recurring tourisms driving sporting events in your community are owned and operated by a local club or promoter? How many organizations/venues in your community exist that would be potential partners in creating locally owned and operated tourism driving sporting events? How many tourism driving sporting events does your organization own and operate annually? How many tourisms driving special events does your organization service on an annual basis? How many unique participants attended special events your organization hosted last fiscal year? As well as similar types of questions.

Once all the above information has been entered by the DMO (CVB/Sports Commission) user, the sports tourism index platform 12 may generate a report. The report may be generated based on an algorithm which weights certain inputs different than others. For example, in the facilities section, the algorithm was developed by talking with numerous rights holders across various sports to determine the needs of each of their events. The requirements for the events were ranked by importance and then averaged to determine the number value assigned for each facility type. For example, for flat field facilities, the highest weighted attributes may be: number of fields, number of fields with lights and number of turf fields. Mid-range weighted attributes may be: number of fields with portable goals, minimum of two team benches per field, number of committable hotel rooms are within a 15-minute drive of the facility, organization’s ability to book this facility. The lowest weighted attributes may be: stadium field, permanent concession stand(s), permanent restrooms, permanent WIFI, number of aux rooms available at facility, number of parking sports and ADA compliant. The above is given as an example and should not be seen in a limiting manner. The weighting may be dynamic and change as industry standards/trends change.

The destination strength, organizational structure and events sections may also use a weighted structure. The weighted structure may be based upon industry information and best practices which has been gathered as well as artificial intelligence which may be used to predict future trends in the industry. For example, artificial intelligence may be used to see trends in sporting events such as one type of sporting tournaments gaining popularity, while another type of sporting tournaments may be losing popularity. Based on trending data, the sports tourism index platform 12 may adjusted the weighting so that field facilities that are able to host sporting tournaments that are gaining popularity may be weighted higher than the field facilities that can only host sporting tournaments of a type that may be losing popularity. The above is given as an example and should not be seen in a limiting manner.

In a similar way to the events section, a rank of importance determined the weight assigned to each element of these categories. For example, in the organizational structure, the budget and staff may be weighted in the following manner:
Highest weighted attributes
   Number of staff members your organization has solely dedicated to sports
   Does your organization have a sports development position?
   Does your organization have a sports services position?
   Does your organization have a grant program or other funding to support events?
Mid-range weighted attributes
   Would your grant program be able to support the following events?
   Does your grant program have the following?
Lowest weighted attributes
   What is your total sports budget not including staff salaries?
   How much of your sports budget is set aside as deal closing funds?
   How much money is attributed to your grant program?
   How much of your sports budget is specifically set aside for travel to industry conferences, relationship building, familiarization tours, sales missions, and networking?

The above is given as an example and should not be seen in a limiting manner. The destination strength, organizational structure and events sections may all use weighted structure as well as artificial intelligence which gathers industry information and best practices for weighting purposes.

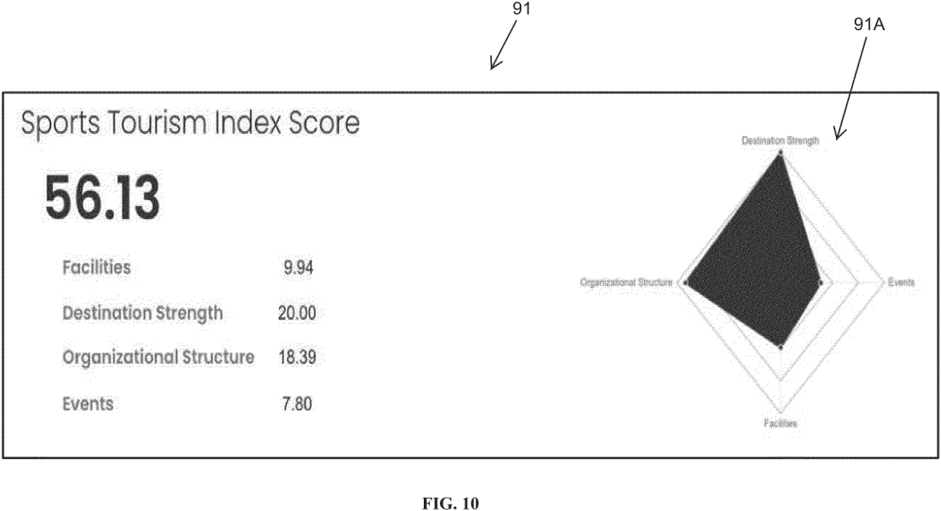

Once the algorithm calculates the scores for each of the four categories, a dashboard report may be generated. In accordance with one embodiment, a sports tourism index report 91 may be generated as shown in FIG. 10. The sports tourism index report 91 may show the weighted score for each of the categories (i.e., facilities available, destination strength, organizational structure and events) as well as a total score which may be the combined score of the different categories. The sports tourism index report 91 may also provide a graphical representation 91A of the scores. The graphical representation 91A may be shaded to show which categories may be the strongest and which categories may be less strong.

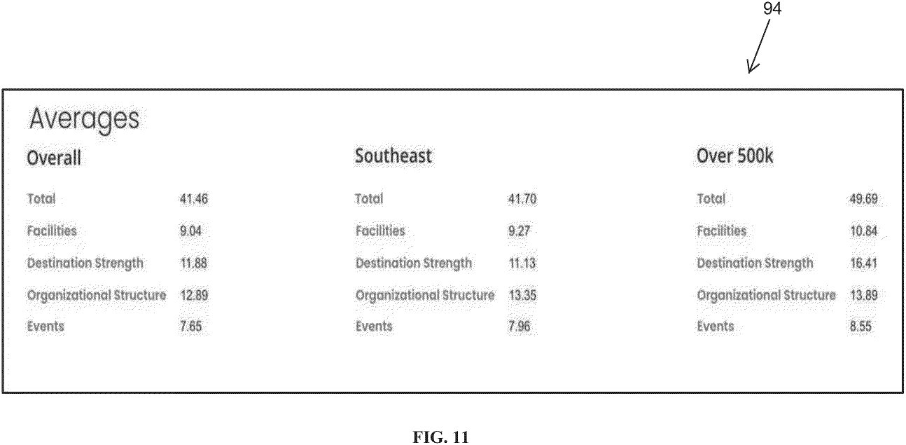

The sports tourism index platform 12 may generate a comparison sports tourism index report 94 as may be shown in FIG. 11. The comparison sports tourism index report 94 may show the weighted score for each of the categories (i.e., facilities available, destination strength, organizational structure and events) as well as a total score for the DMO (CVB/Sports Commission) user. These scores may be compared to an average regional score and a market size score as maybe seen in FIG. 11. Thus, if the DMO (CVB/Sports Commission) user is based in Orlando, Florida, the comparison sports tourism index report 94 may show the average scores for other DMO (CVB/Sports Commission) users in the southeast as well as average scores for similar markets to Orlando, Florida.

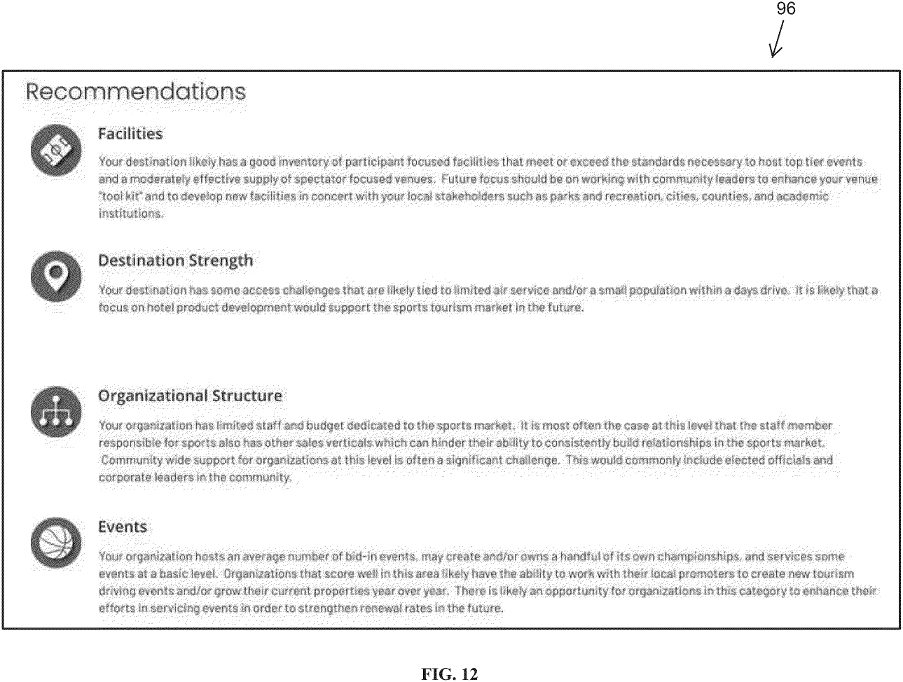

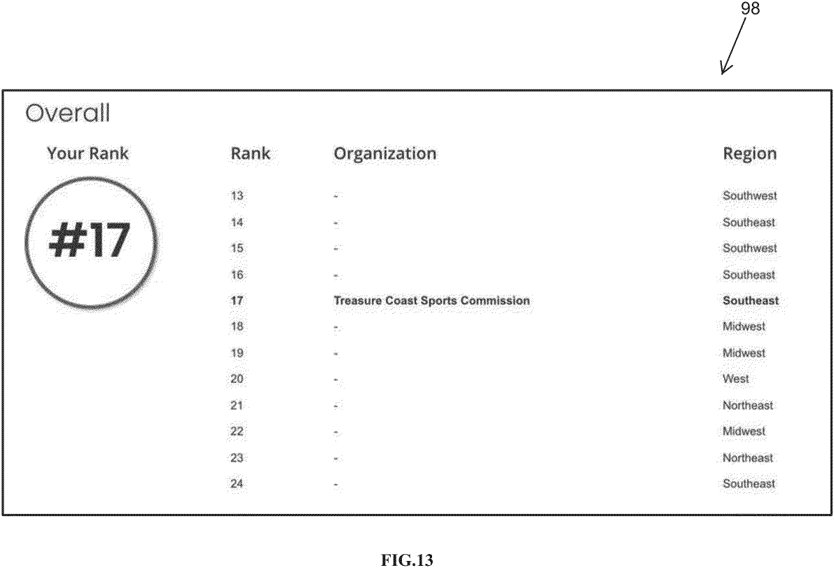

The sports tourism index platform 12 may generate a recommendation report 96 as may be seen in FIG. 12. The recommendation report 96 may provide advice on how to improve the scores for each of the different categories. Artificial intelligence may be used to predict future trends and how the DMO (CVB/Sports Commission) user may want to make changes in order to increase the scores in the different categories. For example, based on current trends, artificial intelligence of the sports tourism index platform 12 may determine that pickle ball tournaments may quadruple in size in the next 3 years. While the DMO (CVB/Sports Commission) user may have sufficient facilities to host pickle ball tournaments for the next year or two, the recommendation report 96 may recommend that additional facilities may need to be built in order for the DMO (CVB/Sports Commission) user to host pickle ball tournaments in the future.

In accordance with one embodiment, the types of reports generated and the comprehensive details of each report may vary based on the access level of the DMO (CVB/Sports Commission) user. Thus, all-access members may receive more detailed reports as opposed to those received by DMO (CVB/Sports Commission) users who may only have limited access. More specifically, the recommendation report 96 may be substantially more detailed for all access DMO (CVB/Sports Commission) users as opposed to those who may only have limited access.

The sports tourism index platform 12 may generate a rankings report 98 as may be seen in FIG. 13. The rankings report 98 may be based on the scores calculated by the sports tourism index platform 12. Rankings may be dynamic and constantly changing on a daily basis. In accordance with one embodiment, these rankings may be blind. Thus, a DMO (CVB/Sports Commission) user can only see their position, not anyone who is above or below them as shown in FIG. 13. The rankings report 98 may use the overall sports tourism index score. The rankings report 98 may be generated for the following classifications: Overall, Region and/or Market-size.

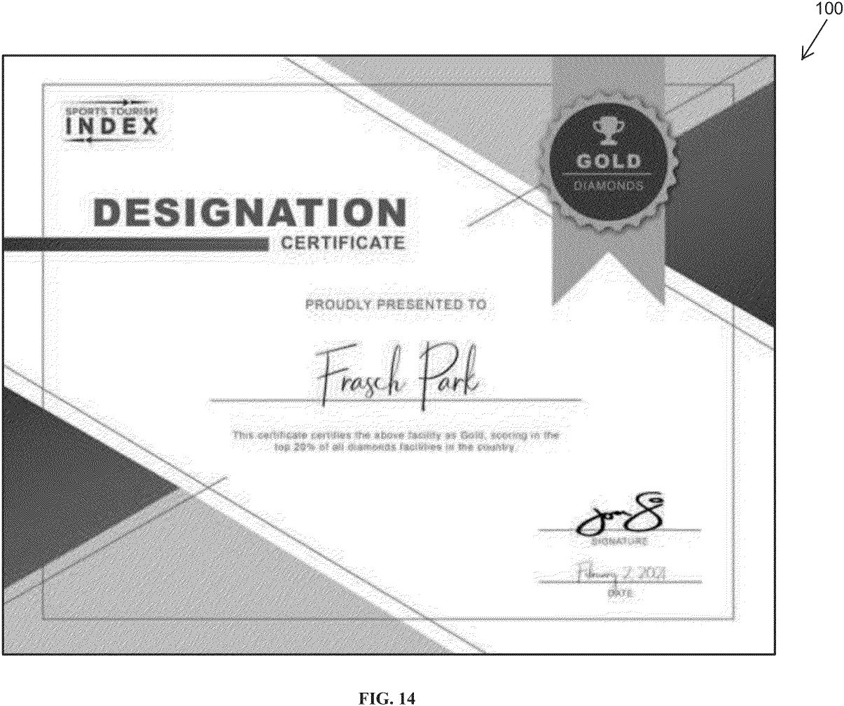

Based on the scores generated, the sports tourism index platform 12 may generate a designation. Based on the designation, designation certificates 100 may be provided as shown in FIG. 14. Designation certificates 100 may be earned based on the overall score, score for each of the four categories, and score for each facility entered in the system 10. Designations may be dynamic and may changing on a daily basis as the scores for each of the categories change over time.

The designation certificates 100 may be broken up into different classifications. In order to qualify for a designation certificate, the scores should reside in a specified range. For example, in accordance with one embodiment, designation certificates 100 may be classified as:
Platinum - top 10%
Gold - top 20%
Silver - top 30%
Bronze - top 40%
Once a designation is earned it is accompanied by the designation certificate 100 as the official “award” for earning that particular score.

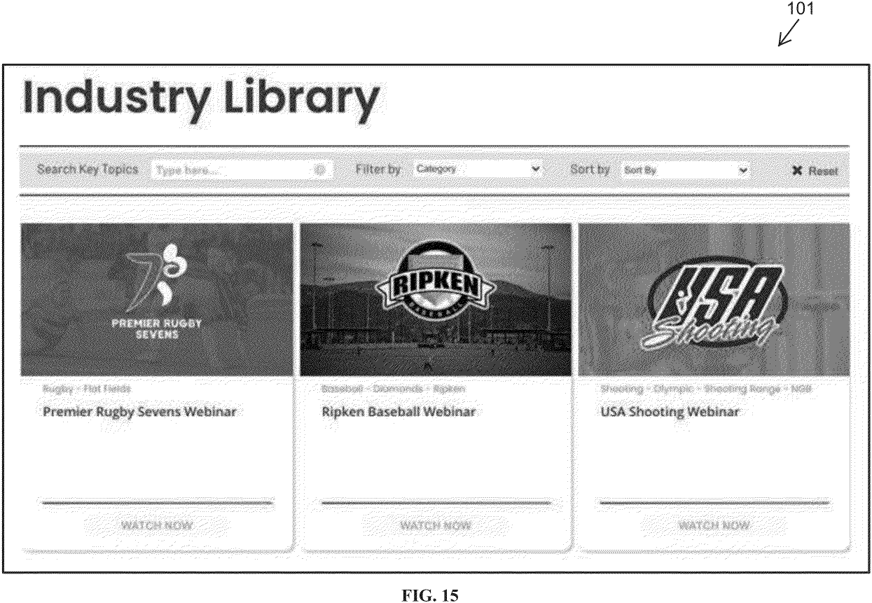

The library may be another tab on the menu section 90. Clicking on the library tab may take the DMO (CVB/Sports Commission) user to a library page 101 as may be seen in FIG. 15. The library page 101 may allow the DMO (CVB/Sports Commission) user to access and view different educational resources. In accordance with one embodiment, the educational resources may be proprietary educational resources produced by the operators of the sports tourism index platform 12. Different types of educational resources may be available to the DMO (CVB/Sports Commission) user based on the access level of the DMO (CVB/Sports Commission) user. For example:
1. The following may be made available for all users regardless of access level:
   Industry education
   Weekly newsletter
   Monthly Sports Tourism Index newsletter
2. Only available to all-access users:
   Webinars

The library page 101 may have different filters, search and sort functions to allow DMO (CVB/Sports Commission) user to find specific content.

The match section of the sports tourism index platform 12 is a unique first-of-a-kind tool for the sports tourism industry. Using the sports tourism index platform 12 database of the event bid information developed from rights holder data input, it matches a DMO (CVB/Sports Commission) user’s sports facilities with the needs of a rights holder user’s events. There are two different ways to use match section.

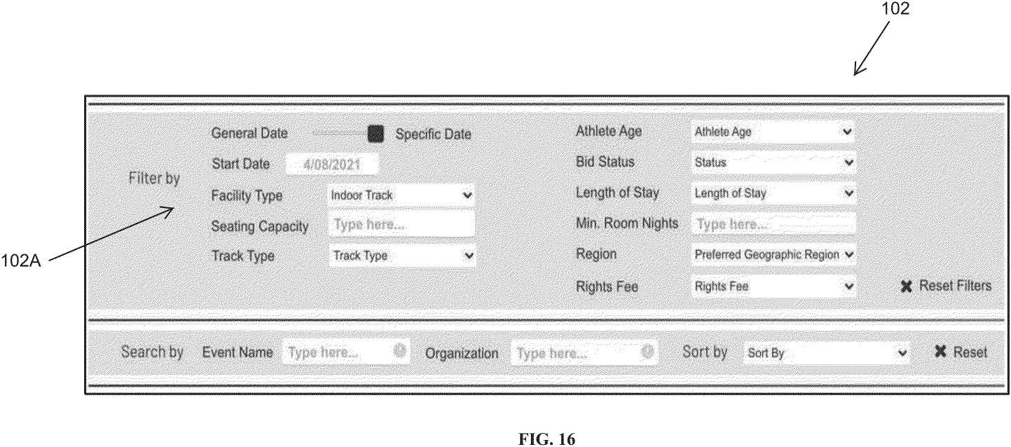

The sports tourism index platform 12 may provide an event finder page 102 as may be seen in FIG. 16. The event finder page 102 may allow any user of the sports tourism index platform 12 to find events by searching an event database of the sports tourism index platform 12. As may be seen in FIG. 16, the event finder page 102 may have a filter area 102A. The filter area 102A may allow a user to enter different information about the event the user is researching. The filter area 102A may include, but is not limited to: date and or date range, facility type, seating capacity, track type, athlete age, bid status, length of the event, minimum nights of stay, region, and similar event information. Based on the information entered, additional options may appear. For example, based on the facility type selected, additional filters may be available if the user selects a specific type of facility (indoor track as shown in FIG. 16). The filter area 102A may also have an area to search for an event name, organization and similar direct information. The user may use the below filter, search, and sort options to find events that would work well for their destination and facilities.

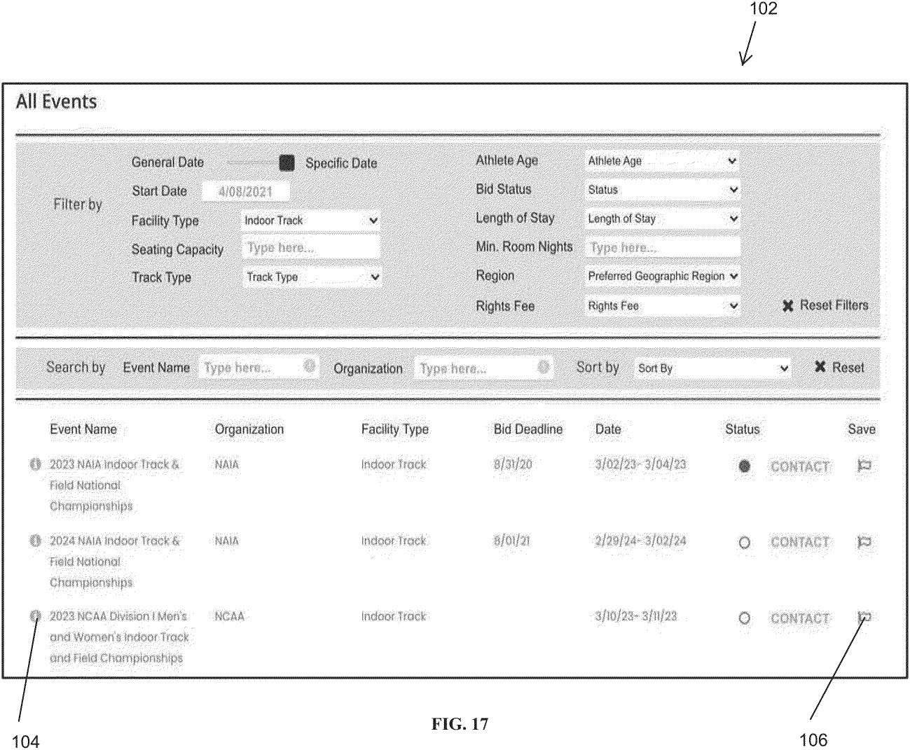

As may be seen in FIG. 17, as the sports tourism index platform 12 looks for events that match the search criteria, the event finder page 102 may begin to display events that match the criteria entered. A user may then click the small “i” information button 104 to show more information on the event and save an event to their “saved events” page using the save flag 106.

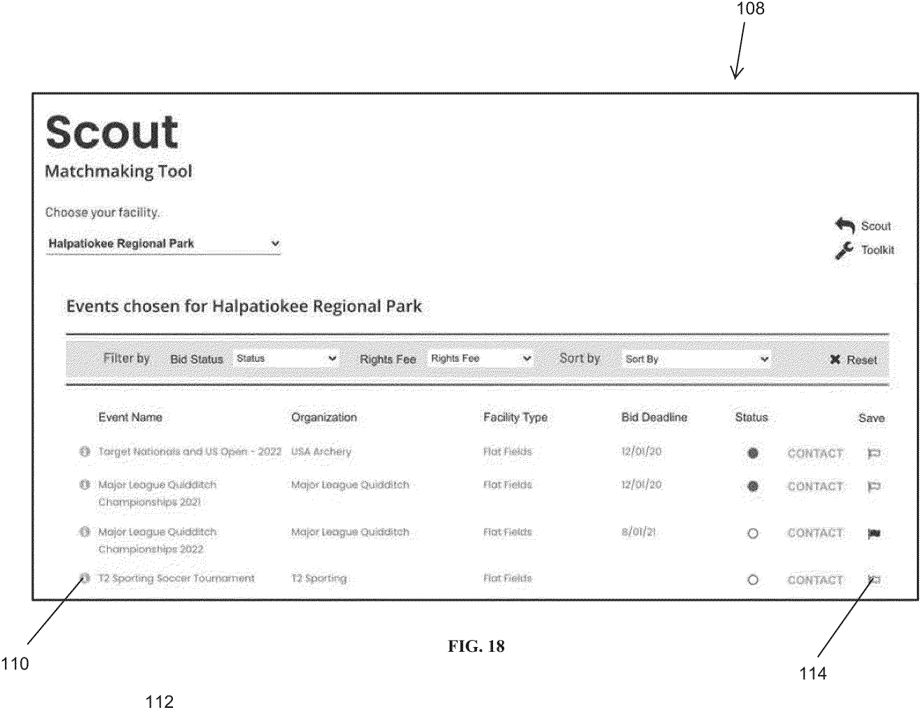

The sports tourism index platform 12 may have a matchmaker page 108 as may be seen in FIG. 18. The matchmaking page 108 may allow users to see the events that the sports tourism index platform 12 may have automatically matched for their facilities. The matches may be created using the facility data input provided directly from the DMO (CVB/Sports Commission) users and the event data input provided from the event rights holder users.

To use the matchmaker function, a user selects one of their facilities from the dropdown facilities menu 110. The matchmaker function of the sports tourism index platform 12 may then uses the attributes of the selected facilities and queries the event database to find events that have similar attributes.

For example, as may be seen in FIG. 18, Halpatiokee Regional Park may be chosen as the facility in the dropdown facilities menu 110. Based on the information entered about Halpatiokee Regional Park, the sports tourism index platform 12 identifies that Halpatiokee Regional Park is a flat field facility. The matchmaker function may then pull events based on two qualifiers: prefer to be in the southeast region or have no regional preference and require 7 fields or less. The matchmaker function may then locate and display events that match the qualifiers. With the results displayed, the user can click the small “i” information button 112 to show more information on the event and save an event to their “saved events” page using the save flag 114.

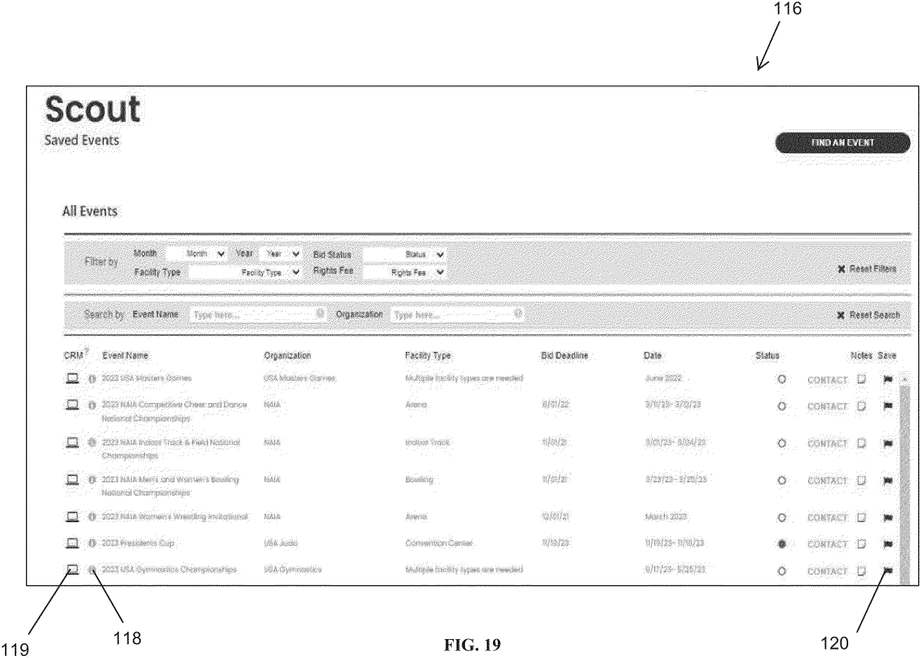

When the DMO (CVB/Sports Commission) user finds an event that interests them, they can save the event using the save flag 114. All the saved events may be displayed on their Saved Events page 116 as may be seen in FIG. 19. All of the DMO (CVB/Sports Commission) user’s saved events may get cataloged and stored in their portal. The information displayed may include but is not limited to: event name, organization, facility type needed, bid deadline, event dates, bid status, rights fee, event owner contact information, regional preference, as well as facility requirements, expected athletes, participants, room nights, athlete gender and age, average length of participant stay and expected room nights generated. The DMO (CVB/Sports Commission) user can then add notes to the saved event. All the saved events can be filtered and searched. Users can click the small “i” information button 118 to show more information on the event and delete the event from the saved events page by clicking the save flag 120.

The Saved Events page 116 may provide the capability for users to directly integrate the sports tourism index platform 12 with select, external, customer relationship management software programs. This may allow for saved event data from the sports tourism index platform 12 to be transferred to a user’s external database with the click of a single button. In the present embodiment, a download button 119 may be provided to allow a user to transfer the saved event data to other programs.

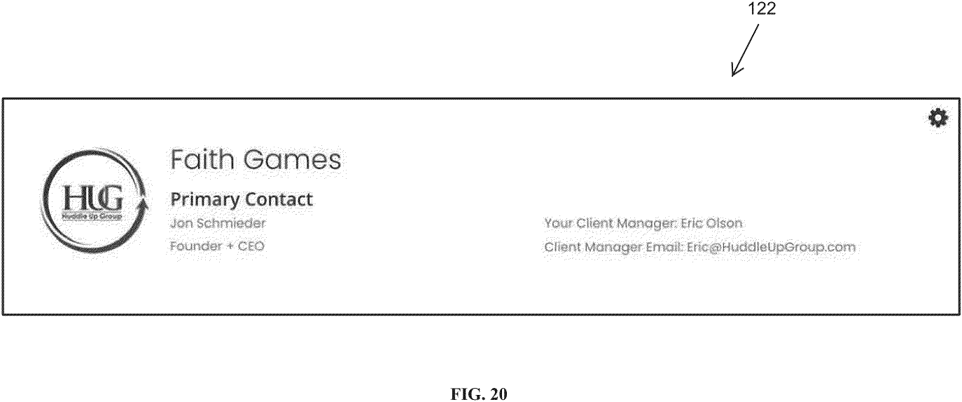

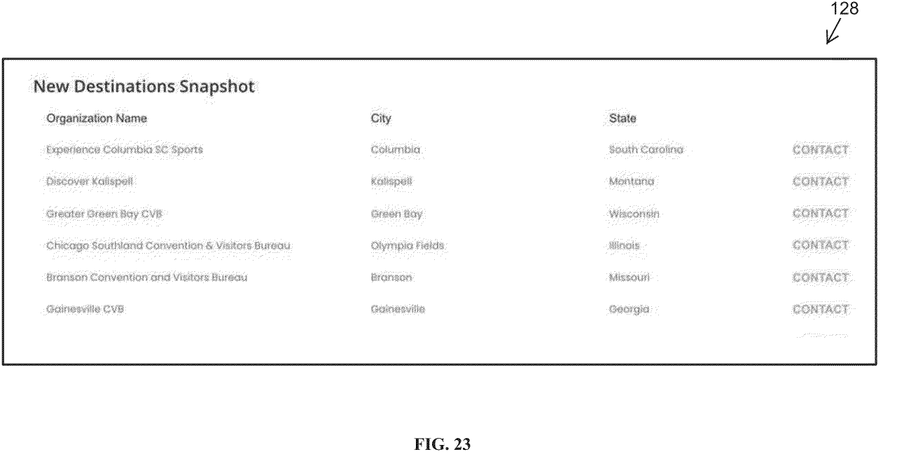

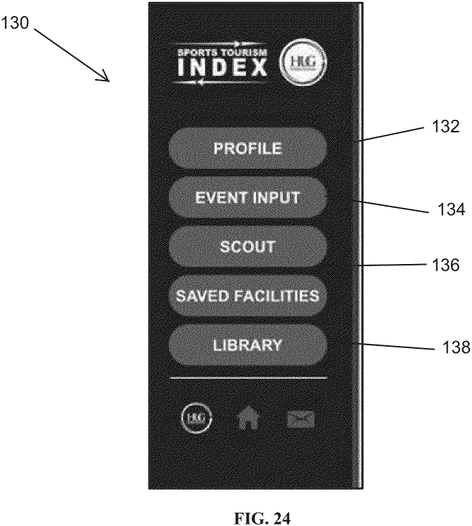

When a rights holder user logs in, they may be directed to their organization profile page. This page may contain four different sections and a menu bar as may be seen in FIGS. 20-24. One section of the organization profile page may be a Profile section 122 as may be seen in FIG. 20. The Profile section 122 may contain the basic information of the right’s holder user. This may include, but is not limited to: the organization name, logo, contact information, and client manager. The information listed on the Profile section 122 may be updated at any time by the rights holder user.

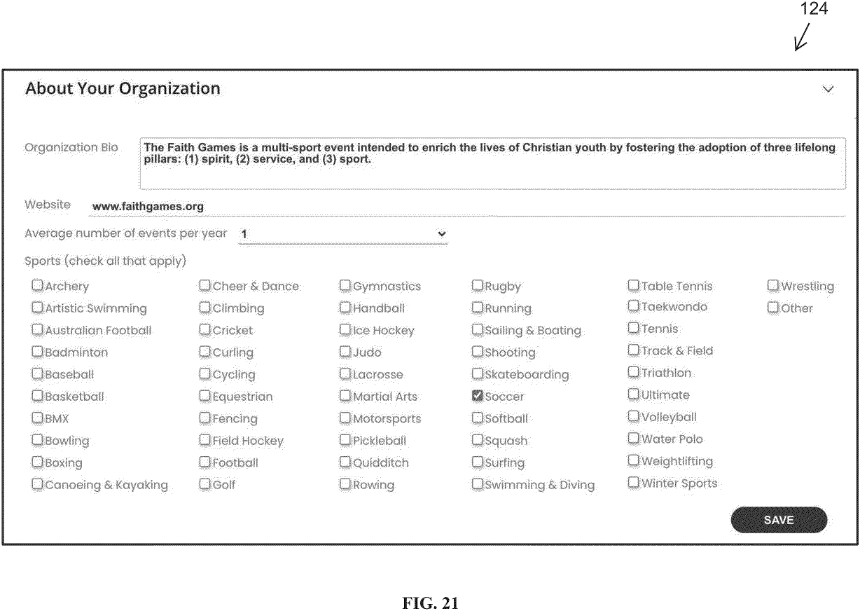

Another section of the organization profile page may be an About the Organization section 124 as may be seen in FIG. 21. The About the Organization section 124 may allow the right’s holder user to provide additional information. For example, the About the Organization section 124 may allow one to enter: an organizational bio, website address, number and type of events held, and similar types of information. The above is given as examples and should not be seen in a limiting manner. Other organizational information may be added without departing from the scope of this invention.

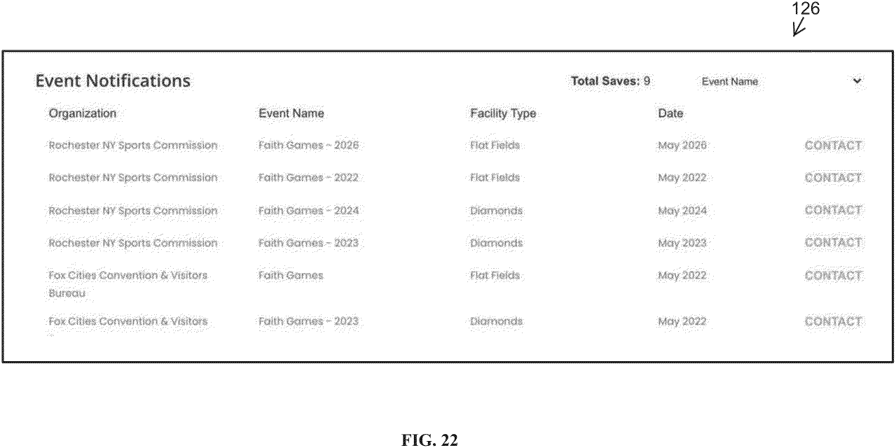

Another section of the organization profile page may be an Event Notification page 126. When a destination user saves a rights holder’s event, the rights holder user may receive a notification in the section of the organizational profile page as shown in FIG. 22. The Event Notification page may show a predetermined number of rights holder’s events that have been saved by a destination user. Other information may also be displayed such as, but not limited to: event name, facility type, date and contact information of the destination user who saved the event.

Another section of the organization profile page may be a New Destination page 128. The New Destination page 128 may show most recently added destinations to the sports tourism index platform 12. In accordance with one embodiment, the New Destination page 128 may show only a predetermined number of the most recently added destinations to the sports tourism index platform 12. For example, the New Destination page 128 may show the 30 most recently added destinations to the sports tourism index platform 12. The New Destination page 128 may show the newly added organizational name, the city/state where the organization is located as well as contact information for the newly added organization. The above is given as an example and should not be seen in a limiting manner.

The organization profile page may have a menu bar 130. The menu bar 130 may allow a rights holder user to navigate to different pages/sections. In accordance with one embodiment the menu bar 130 may have a profile tab 132, an event input tab 134, a matching tab 136, a saved events tab 138 and a library tab 140.

The profile tab 132 may take the rights holder user to their organization profile page. This may allow the rights holder user to update their organization profile page at any time.

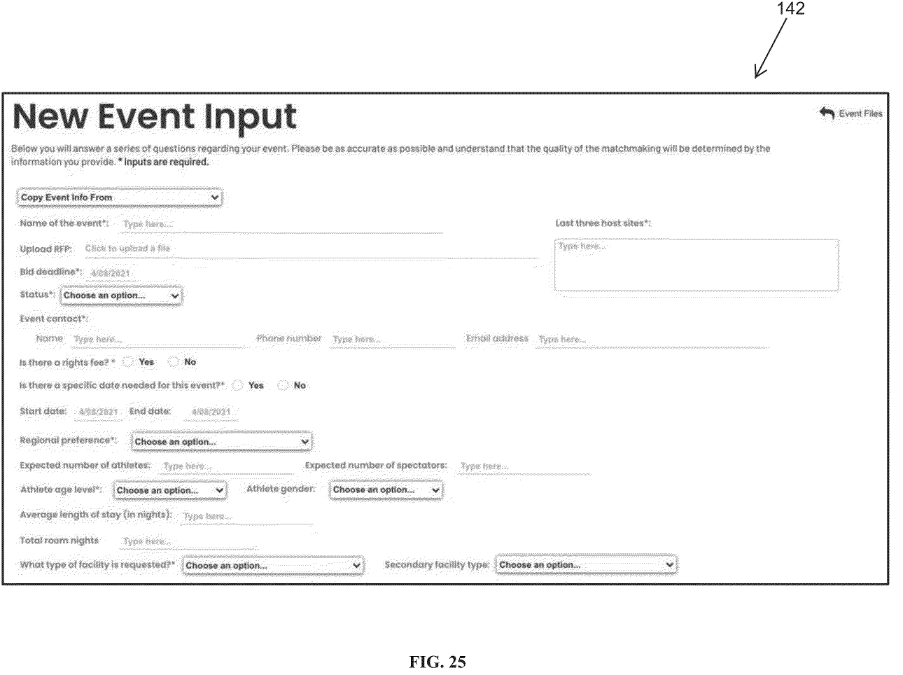

The event input tab 134 may take the rights holder user to a New Event Input page 142 as may be seen in FIG. 25. The New Event Input page 142 may allow the rights holder user to input a new event into the sports tourism index platform 12. Entering valid information in the New Event Input page 142 is important for the user to receive accurate results. Events entered may be updated at any time.

The New Event Input page 142 may have various spaces to enter information related to the event being added. Some of these spaces may be pull down menus to allow one to more easily enter information. Some additional spaces may appear based on the information entered. Once all the information has been entered, the new event may be loaded into the database of the sports tourism index platform 12 and assigned to the organization of the rights holder user.

The scout tab 136 may take the rights holder user to a match section of the sports tourism index platform 12. The match section is a first-of-a-kind tool for the sports tourism industry. Using the database of facility information developed from destination’s data input, it matches the needs of a rights holder user’s events with the attributes of a destination user’s facilities. There are two different ways to use the match section.

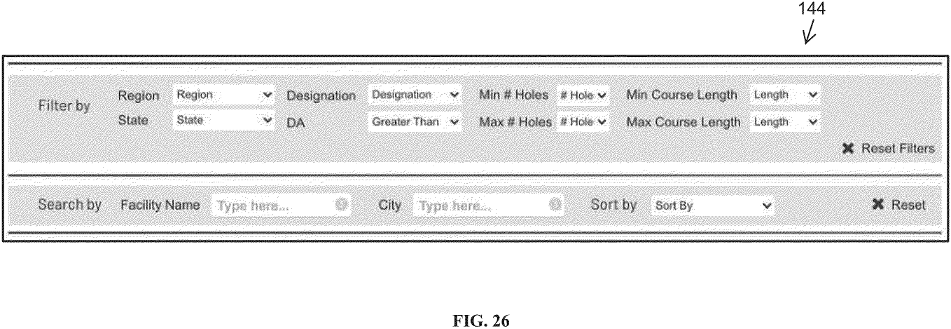

The first way is a facility finder page 144 as may be seen in FIG. 26. The facility finder page 144 allows the rights holder user to find facilities by searching the facility database. The facility finder page 144 may use the different filter, search, and sort options to find facilities that would work well for their events as shown in FIG. 26.

Based on the facility type selected, additional filters will be available. For example, if the rights holder user selected golf courses as the facility type, additional information spaces may be displayed to allow the rights holder user to enter additional information about the type of golf course desired.

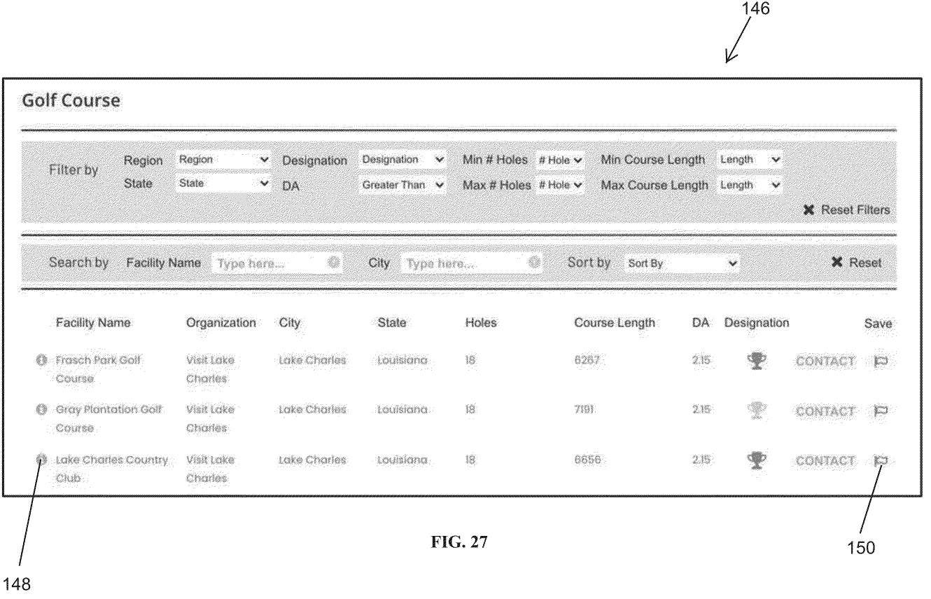

Once the information about the desired facility is entered, a list 146, may be displayed showing all facilities that match the entered criteria as may be seen in FIG. 27. The rights holder can click the small “i” information button 148 to show more information on the facility. To save a specific facility to their “saved facilities” page, the rights holder user may click on the associated the save flag button 150

The second way to use the match section is the facility matchmaker function. This tool allows the rights holder user to see the facilities the match function has automatically matched for their events. The matches may be created using the facility data input provided directly from the destination users and the event data input provided from the event rights holder users.

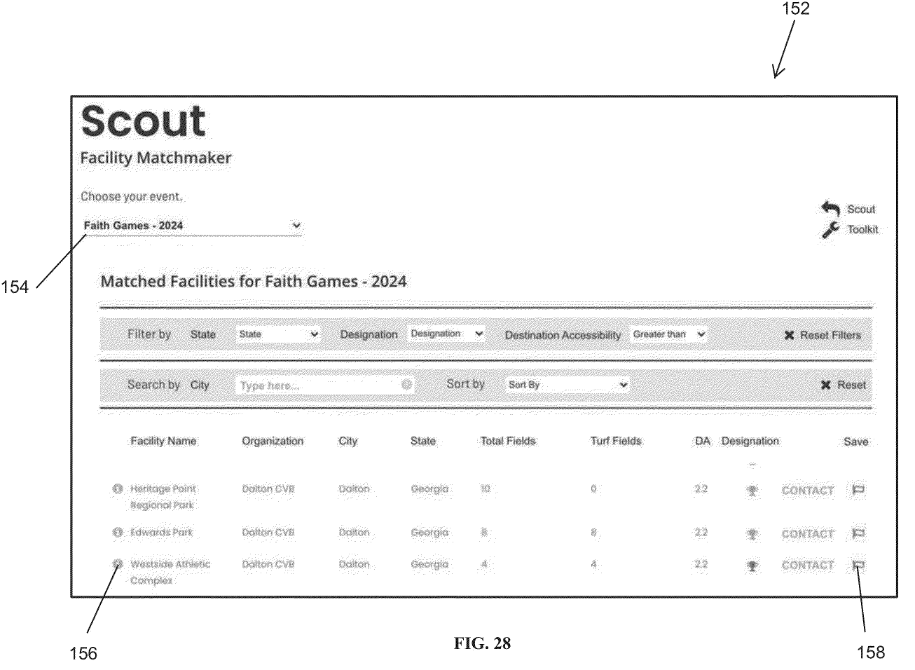

Referring to FIG. 28, a facility matchmaker page 152 may be shown. To use the matchmaker, the rights holder user selects one of their events from the dropdown menu 154. The matchmaker then uses the attributes of the selected event and queries the facility database to find events that have similar attributes. In the embodiment shown, the rights holder user selects the Faith Games 2024. The database of the sports tourism index platform 12 shows that the Faith Games 2024 requires a diamond facility. The matchmaker function then is pulls facilities based upon qualifiers for the Faith Games 2024: Prefer to be in the southeast region or have no regional preference and requires at least 2 fields. A list of the facilities matching the qualifiers for the Faith Games 2024 may then be displayed. The results may be filtered and sorted. Just like the facility finder, users can click the small “i” information button 156 to show more information on the facility. To save a facility to their “saved facilities” page, the rights holder user may click on the save flag button 158.

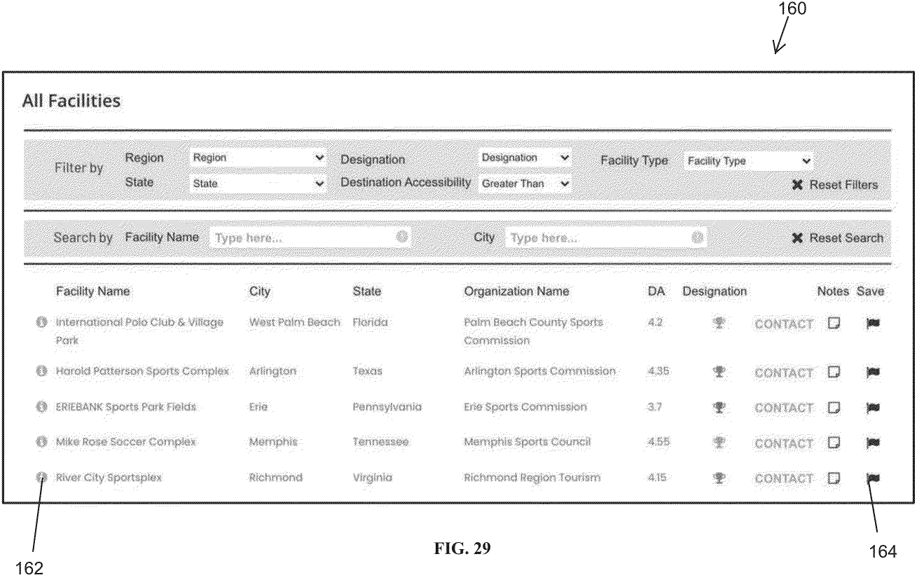

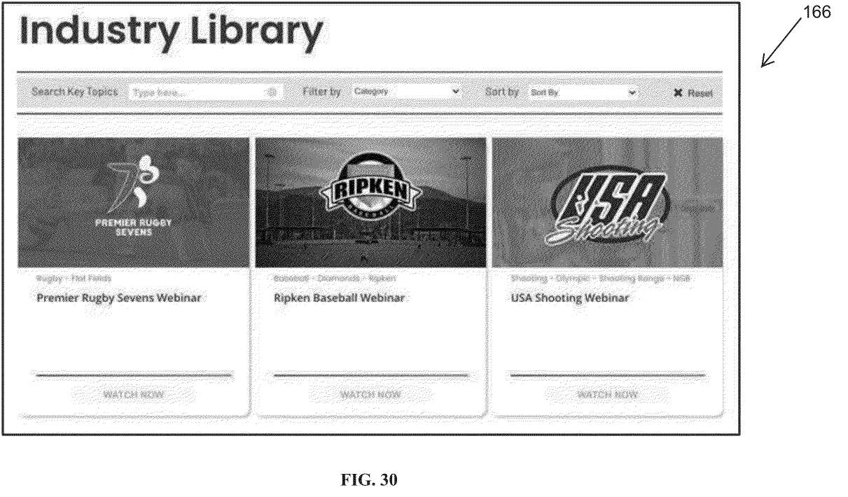

When the rights holder user saves a facility, it may be stored on their Saved Facilities page 160 as may be seen in FIG. 29. All of a rights holder user’s saved facilities get cataloged and stored in their portal. The Saved Facilities page 160 may display a predetermined number of the rights holder user’s saved facilities. Information, such as but not limited to, the facility name, city and state where the facility is located, the organizational name of the DMO (CVB/Sports Commission) where the facility is located as well as contact information for the DMO (CVB/Sports Commission). The Saved Facilities page 160 may allow the rights holder user to add notes about a respective saved facility as well. The rights holder users can click the small “i” information button 162 to show more information on the facility as well as delete the facility from the saved facilities page by clicking the save flag button 164. All of the saved facilities can be filtered and searched by the rights holder user on their respective Saved Facilities page 160.

The library tab 138 may be another tab on the menu section 130. Clicking on the library tab may take the rights holder user to a library page 166. The library page 166 may allow the rights holder user to access and view different educational resources. In accordance with one embodiment, the educational resources may be proprietary educational resources produced by the operators of the sports tourism index platform 12. Different types of educational resources may be available to the rights holder user. For example, all rights holder user may have access to:
Industry education
Weekly newsletter
Monthly Sports Tourism Index newsletter
Webinars

The library page 166 may have different filters, search and sort functions to allow the rights holder user to find specific content.

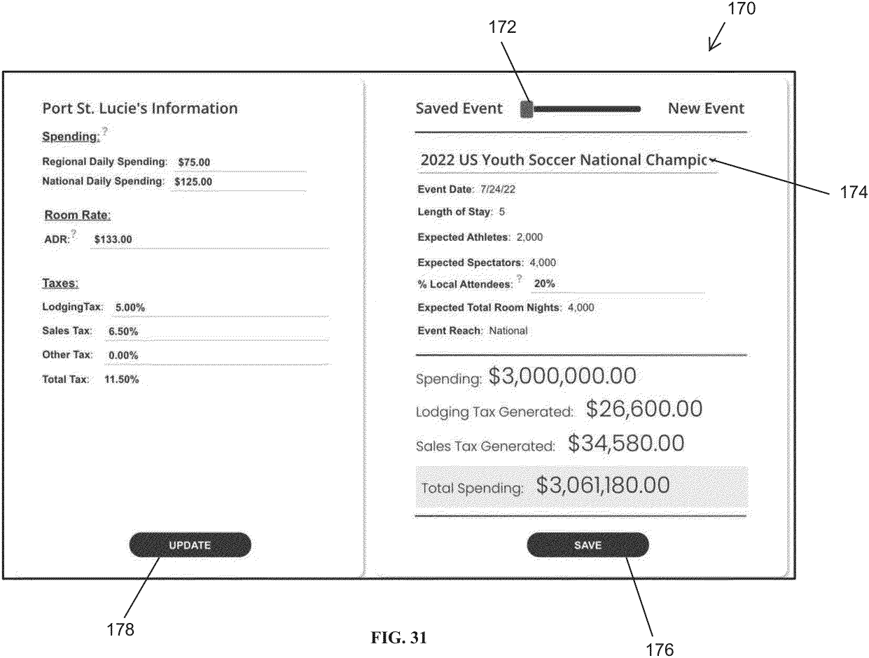

The sports tourism index platform 12 may provide an estimated spending calculator page 170 as may be seen in FIG. 31. The estimated spending calculator page 170 may be used to help the DMO (CVB/Sports Commission) user better understand how an event may financially impact the local community. The estimated spending calculator page 170 may provide estimates and approximate projections based on numerous different factors as well as artificial intelligence. The estimated spending calculator page 170 may take into account factors such as, but not limited to: attendee size, average spending per attendee of similar types of events, taxes an event could generate and similar types of information. Artificial intelligent may be used to track growing trends and/or changes in spending habits and the like. While estimated spending calculator page 170 tries to ensure the accuracy and reliability of the estimates based on extensive research and compiled data sets, should be used only as estimates.

As may be seen in FIG. 31, to use the estimated spending calculator page 170, the DMO (CVB/Sports Commission) user may first enter information about the destination and its taxes. This information may include regional and national daily spending numbers, average daily rate, lodging tax, sales tax, and any other similar taxes. This information may be updated at any time by the DMO (CVB/Sports Commission) user by selecting an Update button 178.

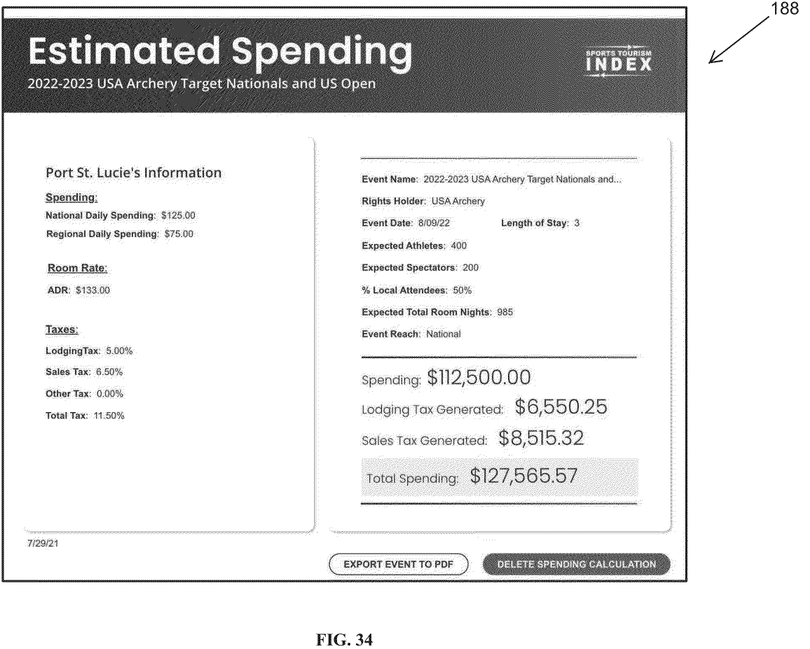

In accordance with one embodiment, there may be two different ways a DMO (CVB/Sports Commission) user can use the estimated spending calculator page 170. As may be seen in FIG. 31, the estimated spending calculator page 170 has a toggle switch 172. The toggle switch 172 may allow the DMO (CVB/Sports Commission) user to select between a saved event and a new event. When the toggle switch 172 is set to “Saved Event”, a user can select their saved event from the dropdown menu 174. Once a saved event has been selected, the corresponding event information associated with the selected saved event may automatically populate the corresponding fields. This information may be pulled directly from the data inputted from the rights holder of the event. The DMO (CVB/Sports Commission) user may then enter an estimate for percent of local attendees. Once this information has been entered, the estimated spending calculator page 170 may calculate and display the estimated spending projections page 188 as may be seen in FIG. 34. A projection snapshot of the estimated spending projection page 188 can be exported to a pdf. The DMO (CVB/Sports Commission) user may then save this information using a Save button 176.

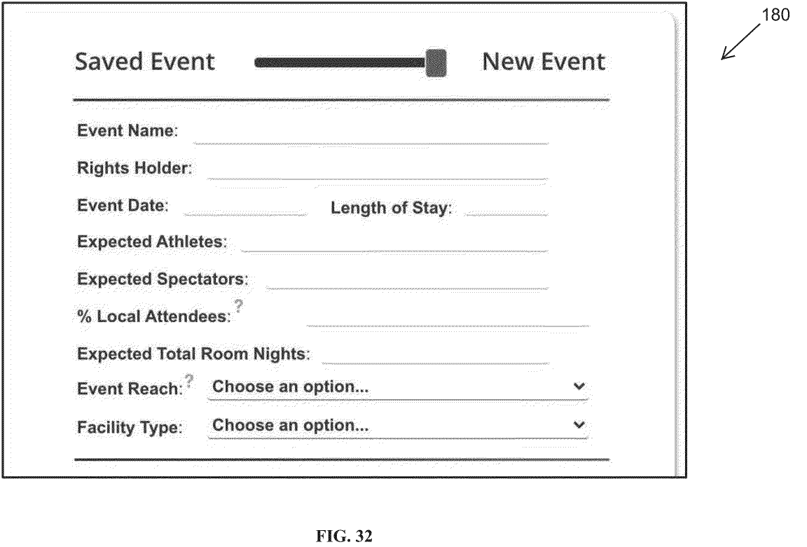

To use the calculator for an event that is not in the saved event database, the DMO (CVB/Sports Commission) user can switch the toggle switch 172 over to “New Event”. The DMO (CVB/Sports Commission) user may then have to manually enters in the event information in the new event fields 180 as may be seen in FIG. 32. Once the new event fields have been populated with the corresponding information, the estimated spending projections may be calculated and displayed as may be seen in the estimated spending projection page 188 of FIG. 34. A projection snapshot of the estimated spending projection page 188 can be exported to a pdf.

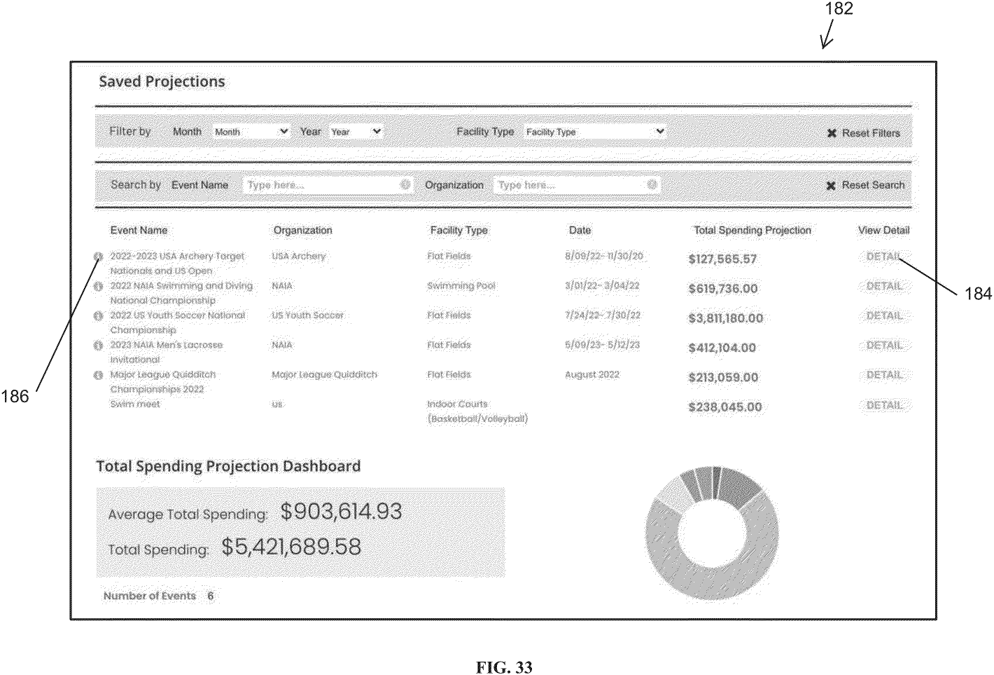

The events with the spending projections saved by the DMO (CVB/Sports Commission) user may collectively be shown on a saved projection page 182 as may be seen in FIG. 33. The saved projection page 182 may contain all the information about the different saved events along with the spending projection for each saved event. The saved projection page 182 may display the average spending per event and total spending. The saved projection page 182 may be filtered by month, year, and facility type. It can also be exported to a pdf or csv file.

The small “i” information button 186 may be used to pull up and display the details of the event while the “detail” button may be used to pull up and display a snapshot of the estimated spending projection.

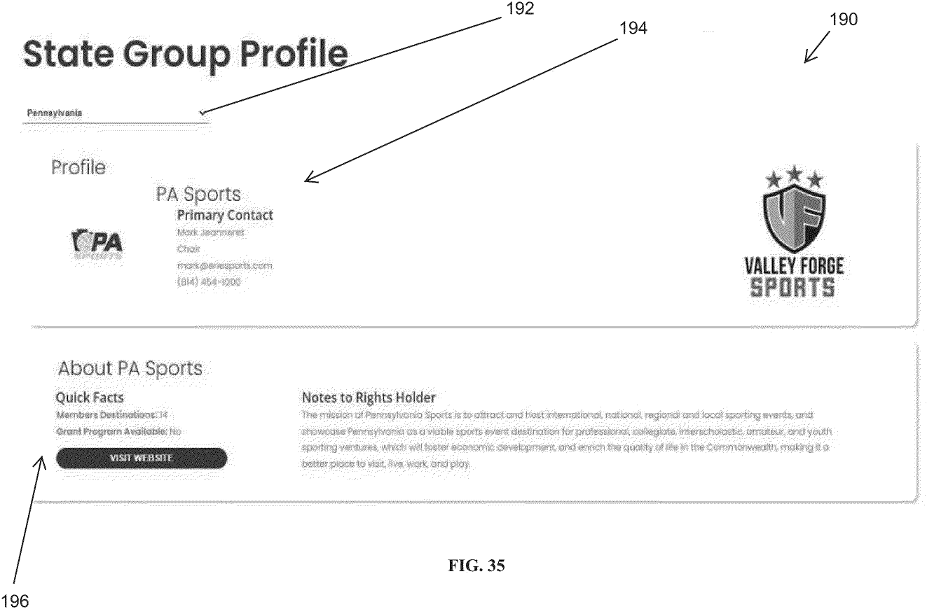

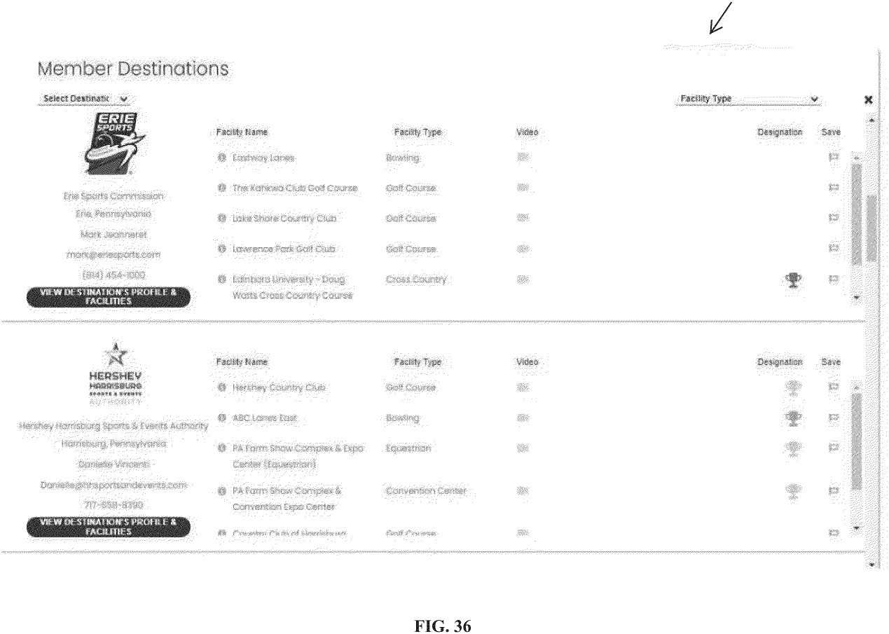

Referring to FIGS. 35 and 36, the sports tourism index platform 12 may provide the capability for users to view relevant data from an entire state sports tourism group/association (i.e., all DMOs associated with a particular state) on one page. A user of the sports tourism index platform 12 may go to a state profile page 190. The state profile page 190 may have a pull down menu 192 for selecting a state for which they would like to view. Once a state is selected, a user may see the primary contact information 194 for the selected organization/state association, and other information. For example, an information section 196 may show: # of destinations belonging to the group, grant program availability, a link to the group’s official website, a note to rights holders from the group, as well as other information.

Once a state is selected, a user may further see a scrolling, sortable list of each individual destination member of the state group. From a Member Destination section 198, a user would have access to see each individual destinations primary contact information, a link to visit the destination’s profile, facility names, facility types (sortable), complete facility information (by clicking the icon labeled, a link to video on the facility, the facility’s designation, and have the ability to save the destination.

The foregoing description is illustrative of particular embodiments of the application, but is not meant to be a limitation upon the practice thereof. The following claims, including all equivalents thereof, are intended to define the scope of the application.

What is claimed is:

1. A computing device comprising:
a processor;
a display coupled to the processor;
a user interface coupled to the processor for entering data into the computing device; and
a memory coupled to the processor, the memory storing program instructions that when executed by the processor, causes the processor to:
connect with a server hosting a sports tourism index platform for matching event rights holders with municipality destination marketing organizations (DMOs);
add a plurality of DMOs, wherein each DMO added includes name and contact information of each DMO, sporting facilities associated with each DMO, capacities of the sporting facilities associated with each DMO, parking facilities for the sporting facilities associated with each DMO, number of hotels within a predefined radius of each of the sporting facilities associated with each DMO, and staffing and budget of associated with each DMO;
add a plurality of event rights holders, wherein each event rights holder added includes name and contact information of each event rights holders associated with each event rights holder, biographical information associated with each event rights holder, sporting events hosted by each event rights holder, and facility requirements of each sporting event hosted by each event rights holder; and
match the sporting events of the plurality of event rights holders with each sporting facility of the plurality of DMOs that match the and facility requirements.

2. The computing device of claim 1, wherein the memory storing program instructions that when executed by the processor, causes the processor to display a profile page of the corresponding DMO when an individual associated with the corresponding DMO accesses the sports tourism index platform, the profile page having a menu to access associated pages of the profile page.

3. The computing device of claim 2, wherein the memory storing program instructions that when executed by the processor, causes the processor to display a facility notification page of the corresponding DMO when an associated sporting facility of the corresponding DMO is saved by any of the plurality of sporting event rights holders.

4. The computing device of claim 2, wherein the memory storing program instructions that when executed by the processor, causes the processor to display a new sporting event notification page of the corresponding DMO when a new sporting event is added and open for bidding by any of the plurality of sporting event rights holders to the sports tourism index platform.

5. The computing device of claim 4, wherein the memory storing program instructions that when executed by the processor, causes the processor to display the new sporting event notification page of the corresponding DMO, the new sporting event notification page of the corresponding DMO displaying name of the new sporting event added, organization hosting the new sporting event added, sporting facility type requested by the new sporting event added, bid date of the new sporting event added, date of the new sporting event added and a status of the new sporting event added.

6. The computing device of claim 2, wherein the memory storing program instructions that when executed by the processor, causes the processor to display an index report of the corresponding DMO, wherein the index report displays a score of the corresponding DMO based on the sporting facilities associated with the corresponding DMO, destination strength based on hospitality industry within a predefined radius of a municipality of the corresponding DMO, organizational structure of the corresponding DMO, and tourism events within a predefined radius of a municipality of the corresponding DMO.

7. The computing device of claim 6, wherein the memory storing program instructions that when executed by the processor, causes the processor to dynamically adjust and weight the score of the index report based on trending data of popularity of types of sporting tournaments, planned sporting facilities, changes in organizational structure of the plurality of DMOs, and similar criteria.

8. The computing device of claim 6, wherein the memory storing program instructions that when executed by the processor, causes the processor to display a comparison index report displaying the score of the corresponding DMO in relation to scores of other of the plurality of DMOs that are in a same geographical region or of has a population within a predefined range of the municipality of the corresponding DMO.

9. The computing device of claim 6, wherein the memory storing program instructions that when executed by the processor, causes the processor to display a recommendation report of the corresponding DMO, wherein the recommendation report displays suggestions on how to increase the score of the corresponding DMO by increasing a desired type or types of sporting facilities associated with the corresponding DMO, adding a desired type of amenities to increase destination strength, and changes to the organizational structure of the corresponding DMO.

10. The computing device of claim 6, wherein the memory storing program instructions that when executed by the processor, causes the processor to display an overall comparison index report displaying the score of the corresponding DMO in relation to a predefined number of other scores of other of the plurality of DMOs both above and below the score of the corresponding DMO.

11. The computing device of claim 1, wherein the memory storing program instructions that when executed by the processor, causes the processor to display a profile page of the corresponding event rights holder when an individual associated with the corresponding event rights holder accesses the sports tourism index platform, the profile page of the corresponding event rights holder having a menu to access associated pages of the profile page of the corresponding event rights holder.

12. The computing device of claim 11, wherein the memory storing program instructions that when executed by the processor, causes the processor to display an event notification page of the corresponding event rights holder, wherein the event notification page of the corresponding event rights holder displays sporting events associated with the corresponding event rights holder that have been saved by at least one of the plurality of DMOs.

13. The computing device of claim 11, wherein the memory storing program instructions that when executed by the processor, causes the processor to display a new destination page of the corresponding event rights holder, wherein the new destination page of the corresponding event rights holder displays newly added DMO’s to the sports tourism index platform.

14. The computing device of claim 11, wherein the memory storing program instructions that when executed by the processor, causes the processor to display a new event input page of the corresponding event rights holder, wherein the new event input page of the corresponding event rights holder displaying input areas allowing entering a new sporting event of the corresponding event rights holder to be uploaded to the sports tourism index platform.

15. The computing device of claim 11, wherein the memory storing program instructions that when executed by the processor, causes the processor to display a matchmaker page of the corresponding event rights holder, wherein the matchmaker page of the corresponding event rights holder displaying any sporting facility that meets the facility requirements of each sporting event of the corresponding event rights holder and the associated DMO of each sporting facility that meets the facility requirements.

16. The computing device of claim 11, wherein the memory storing program instructions that when executed by the processor, causes the processor to display a sporting facility search page of the corresponding event rights holder, the sporting facility search page of the corresponding event rights holder displaying a menu allowing the corresponding event rights holder to search any sporting facility that meets the facility requirements of each sporting event of the corresponding event rights holder and the associated DMO of each sporting facility that meets the facility requirements.

17. The computing device of claim 11, wherein the memory storing program instructions that when executed by the processor, causes the processor to display a saved sporting facility page of the corresponding event rights holder, the saved sporting facility page of the corresponding event rights holder displaying a predetermined number of sporting facilities the corresponding event rights has saved.

18. The computing device of claim 1, wherein the memory storing program instructions that when executed by the processor, causes the processor to display an estimated spending calculator page calculating an amount of money a selected sporting event generates for a corresponding community associated with a selected DBO.

19. The computing device of claim 1, wherein the memory storing program instructions that when executed by the processor, causes the processor to display a state profile page having a menu to select a desired state for viewing all DBOs associated with the selected desired state.

20. The computing device of claim 19, wherein the memory storing program instructions that when executed by the processor, causes the processor to display a sortable list of each individual DMO of the select desired state.
